(19) United States
(12) Patent Application Publication
(10) Pub. No.: US 2017/0214559 A1
(43) Pub. Date: Jul. 27, 2017

(54) TRANSMISSION/RECEPTION OF A PARTIAL SC-FDM SYMBOL

(71) Applicant: NOKIA SOLUTIONS AND NETWORKS OY

(72) Inventors: Gilberto BERARDINELLI, Aalborg (DK); Fernando TAVARES, Aalborg (DK); Frank FREDERIKSEN, Klarup (DK)

(21) Appl. No.: 15/114,160

(22) PCT Filed: Jan. 29, 2014
(86) PCT No.: PCT/EP2014/051686

§ 371 Date: Jul. 26, 2016

(51) Int. Cl. H04L 27/12; H04L 25/03; H04L 29/06

(52) U.S. Cl. CPC H04L 27/122; H04L 69/22; H04L 25/03006; H04L 27/2601

(57) ABSTRACT

A method is disclosed for signal processing in a radio system. The method comprises generating (801), in an apparatus (602), a single carrier frequency division multiplexing SC-FDM signal having a shorter duration than a time symbol duration defined by a radio standard applied in the radio system. The signal is transmitted (802) from the communications apparatus (602). The method comprises receiving (803) said signal from the communications apparatus (602), wherein orthogonality of frequency subcarriers is maintained at a receiver (601) of the signal.

### FIELD OF THE INVENTION

The exemplary and non-limiting embodiments of this invention relate generally to wireless communications networks, and more particularly to signal processing.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

OFDM (orthogonal frequency division multiplexing) is a form of FDM where carrier signals are orthogonal to each other. Thus cross-talk between sub-channels is eliminated. Since low symbol rate modulation schemes suffer less from inter-symbol interference caused by multi-path propagation, a number of low-rate data streams are transmitted in parallel instead of a single high-rate stream. Since the duration of each symbol is long, a guard interval may be inserted between the OFDM symbols, thus eliminating the inter-symbol interference. A cyclic prefix transmitted during the guard interval comprises the end of the OFDM symbol copied into the guard interval, and the guard interval is transmitted followed by the OFDM symbol.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise methods, an apparatus, and a computer program product as defined in the independent claims. Further embodiments of the invention are disclosed in the dependent claims.

An aspect of the invention relates to a method for signal processing in a radio system, the method comprising generating, in a communications apparatus, a single carrier frequency division multiplexing SC-FDM signal having a shorter duration than a time symbol duration defined by a radio standard applied in the radio system; transmitting the signal from the communications apparatus, wherein orthogonality of frequency subcarriers is maintained at a receiver of the signal.

A further aspect of the invention relates to a method for signal processing in a radio system, the method comprising receiving a signal from a communications apparatus, said signal being generated in the communications apparatus and comprising a single carrier frequency division multiplexing SC-FDM signal having a shorter duration than a time symbol duration defined by a radio standard applied in the radio system; wherein orthogonality of frequency subcarriers is maintained at a receiver of the signal.

A still further aspect of the invention relates to an apparatus comprising at least one processor; and at least one memory including a computer program code, wherein the at least one memory and the computer program code are configured to, with the at least one processor, cause the apparatus to perform any of the method steps. A still further aspect of the invention relates to a computer program product comprising executable code that when executed, causes execution of functions of the method.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments with reference to the attached drawings, in which

FIG. 1 illustrates frequency domain scheduling (a) vs. time domain scheduling (b);

FIG. 2 illustrates exemplary usage of short SC-FDM transmission compared to traditional frequency domain scheduling;

FIG. 3 illustrates short SC-FDM signal generation according to an exemplary embodiment;

FIG. 4 illustrates a snapshot of the short SC-FDM signal;

FIG. 5 illustrates multiplexing of users in the downlink by using a short SC-FDM principle;

FIG. 6 shows a simplified block diagram illustrating an exemplary system architecture;

FIG. 7 shows a simplified block diagram illustrating exemplary apparatuses;

FIG. 8 shows a messaging diagram illustrating an exemplary messaging event according to an embodiment of the invention;

FIG. 9 shows a messaging diagram illustrating an exemplary messaging event according to an embodiment of the invention;

FIG. 10 shows a schematic diagram of a flow chart according to an exemplary embodiment of the invention;

FIG. 11 shows a schematic diagram of a flow chart according to an exemplary embodiment of the invention.

### DETAILED DESCRIPTION OF SOME EMBODIMENTS

An exemplary embodiment relates to orthogonal frequency division multiplexing/single-carrier frequency division multiplexing (OFDM/SC-FDM) signal processing/generation. OFDM modulation is a multicarrier technique which has been accepted by several radio standards such as WiFi and long term evolution (LTE) given its capability of coping with fading channels in a cost-effective manner and its simple extension to multiple input multiple output (MIMO) antenna schemes.

SC-FDM is a straightforward add-on over OFDM allowing emulating single carrier transmission, with remarkable advantages in terms of power efficiency.

An existing embodiment aims at reducing power consumption of user equipment (UE) by limiting ON (or alternatively an active) time of a radio-frequency circuitry in both transmit and receive operations. In that sense, an exemplary embodiment is particularly suited for low power devices (e.g. for machine-to-machine type of communication) aiming at transmitting small data packets with little information content.

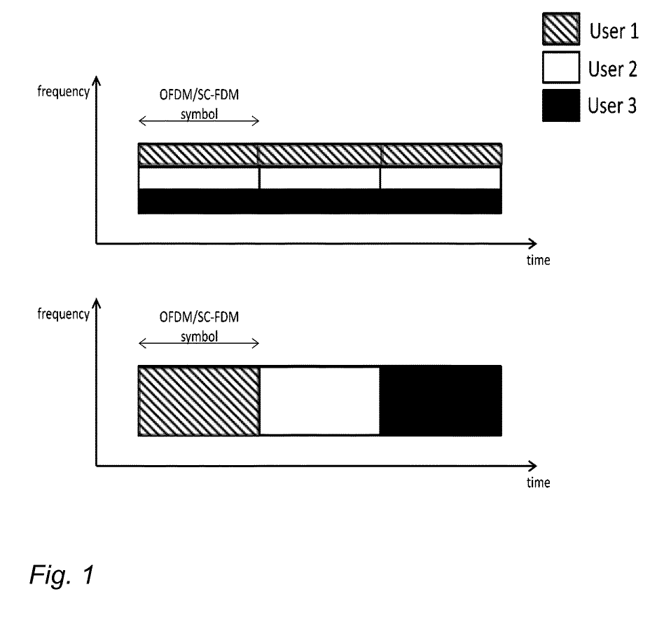

In existing OFDM/SC-FDM based radio standards such as LTE/LTE-A, a minimum transmission time granularity corresponds to a duration of an OFDM/SC-FDM symbol, i.e. each AP/UE needs to be transmitting as a minimum for a duration of an OFDM/SC-FDM symbol (e.g. 66.67 μs in LTE/LTE-A). The multiplexing of users within a same OFDM/SC-FDM symbol is obtained with frequency domain scheduling, while time domain scheduling can only be applied by considering the entire OFDM/SC-FDM symbol as a minimum unit (see FIG. 1). This lack of time domain granularity has the following drawbacks. Devices need to transmit at minimum for an entire OFDM symbol duration even in case of a minimum amount of data (e.g. ACK/NACK reports) or in case they are transmitting the last bytes in their data queue. This may considerably affect the power consumption of the device due to a long ON time of the radio frequency circuitry. Data processing can only start upon reception of the entire OFDM symbol. This is a requirement for maintaining the orthogonality of frequency subcarriers, due to IFFT processing. Such a constraint increases the latency of the data processing.

In existing solutions, handling of users with low data traffic volumes has been addressed by multiplexing the users in the code domain—that is, the users share the same transmission resources for the full duration of the OFDM symbol, and then the users are assigned (semi-)orthogonal codes that allow for a separation after processing at an access point (or a base station) AP. Examples of such structures include uplink transmission of HARQ acknowledgements for HSPA (HS-DPCCH) as well as scheduling request (SR) transmission for the LTE systems.

Also, different methods for generating OFDM/SC-FDM signals having zeros (or very low power samples) at their tail have been suggested. An exemplary implementation of short SC-FDM transmission/reception may be obtained such that a SC-FDM signal with low power amplitude at its tail is generated as a modified form of a traditional SC-FDM transmitter chain as disclosed below.

An exemplary embodiment discloses a method for transmitting/receiving a SC-FDM signal having a shorter duration than the symbol duration defined by the radio standard where the devices are operating, while maintaining subcarrier orthogonality at a receiver. In this way, a user equipment (or mobile device) UE may be set to transmit only over a portion of the time symbol. In case of short data packets to be sent, this enables reducing the total ON time of the radio frequency circuitry. Similarly, in case an exemplary embodiment is applied to the downlink, AP is able to schedule control information for multiple users over different portions of the same OFDM symbol, and each UE is able to turn on its receive chain only for a corresponding portion of time (assuming that such time allocation has been previously signalled).

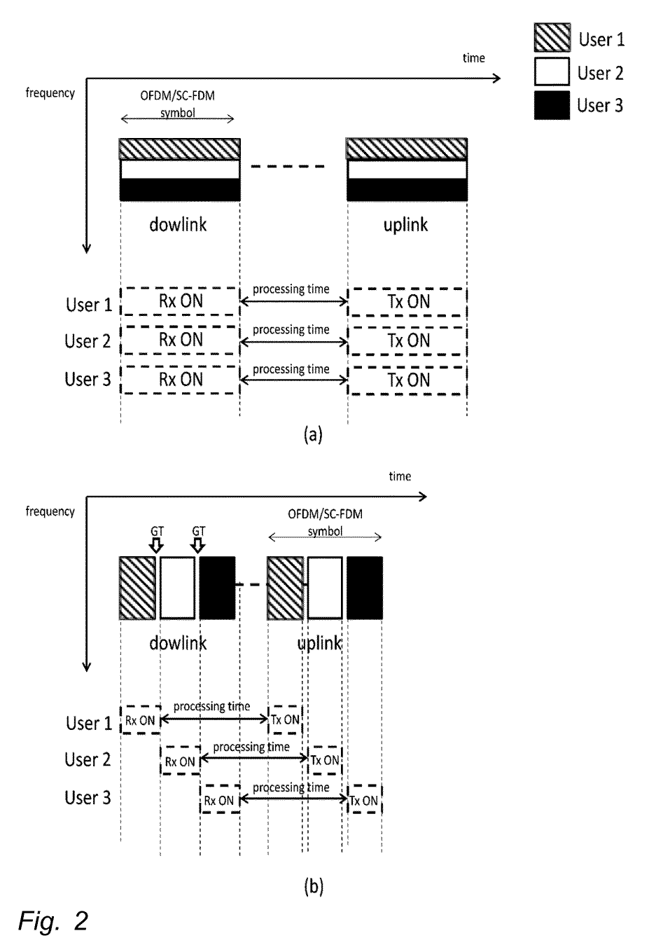

FIG. 2 illustrates exemplary usage of the short SC-FDM transmission (b) compared to traditional frequency domain scheduling (a). The concept is illustrated in terms of reduced ON time as well as lower latency. In FIG. 2, the case of frequency domain scheduling is also displayed for the sake of comparison. In this example, the short SC-FDM transmission is applied both on the downlink and uplink. It is further assumed that the system is fully synchronized, i.e. AP and UE share a common knowledge of frame timing, and AP and UE are both operating in a TDD mode. One control symbol is allocated for each transmission direction in a time interleaved fashion. Considering the case of AP that schedules information to multiple UEs in the control symbol, UEs decode this information and reply in the uplink control symbol (e.g. sounding request in the downlink and sounding reference signal transmission in the uplink).

In case of traditional frequency domain scheduling, AP allocates different frequency resources to each UE, and transmits simultaneously their information in the control symbol. As a consequence, UEs need to activate their receiver chain for an interval of time at least equal to the duration of the control symbol. Upon reception of the entire symbol, UEs need a certain time for decoding data and processing information before replying. Each of the UEs then transmits simultaneously their messages in different frequency resources of the uplink control symbol. The frame is supposed to be defined in such a way that the uplink transmission may occur after a time interval which is longer than the expected processing time of a previously retrieved downlink data.

In case of the short SC-FDM transmission, AP schedules UEs over different portions of the same time symbol with an appropriate guard time (GT) between transmission opportunities (to address and mitigate any potential inter-symbol interference due to a time dispersive nature of the radio channel).

As a consequence, UEs only need to receive their dedicated portions of samples, and turn OFF their receive circuitry for the remaining part of the symbol. By assuming the same processing time than the previous case, UEs are then ready for transmitting their replies with a certain advance. This enables the design of a shorter frame structure with reduced latency and power consumption. Moreover, UEs transmit their samples only over a portion of the time symbol, thus reducing the ON time of the RF circuitry. Finally, in case UEs are still occupying the same frequency band, it may be possible for AP to obtain, for instance, channel sounding information over a certain bandwidth from multiple UEs with a unique time symbol.

An exemplary embodiment discloses generating a SC-FDM signal having a transmission time shorter than the symbol duration defined by the standard where the device is operating, while preserving the numerology of the standard (i.e. subcarrier spacing).

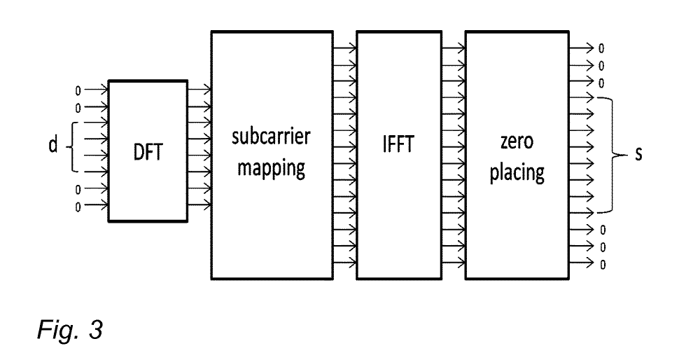

Such a short SC-FDM signal may be generated with a modified form of an existing SC-FDM transmitter chain (see FIG. 3). It is assumed that:
N_{IFFT} denotes IFFT size,
N denotes the length of an original data vector (DFT size),
F_{P} denotes a P×P FFT matrix,
M denotes a N_{IFFT}×N subcarrier mapping matrix,
M denotes a vector of zeros having a length x,
└x┘ denotes the largest integer smaller than x,
(•)^{T} denotes a transpose operator.

Supposing that data is to be transmitted in the interval of time samples [n₀,n₁] of the SC-FDM symbol, with n₀≧0 and n₁<N_{IFFT}. Such a portion of time samples may accommodate a set of data symbols d having a length

$${N}_{data} = ⌊ \frac{( {n}_{1} - {n}_{0} + 1 ) N}{{N}_{IFFT}} ⌋ .$$

Defining then the vector

$$q = [ {0}_{⌊ \frac{{n}_{0 N}}{{N}_{IFFT}} ⌋} d {0}_{⌊ \frac{( {N}_{IFFT} - {n}_{1} + 1 ) N}{{N}_{IFFT}} ⌋} ] ,$$

with a length N. Such a vector undergoes traditional SC-FDM modulation steps. An output vector s is then given by s=F_{N}_{_{IFFT}}⁻¹MF_{N}q^{T}.

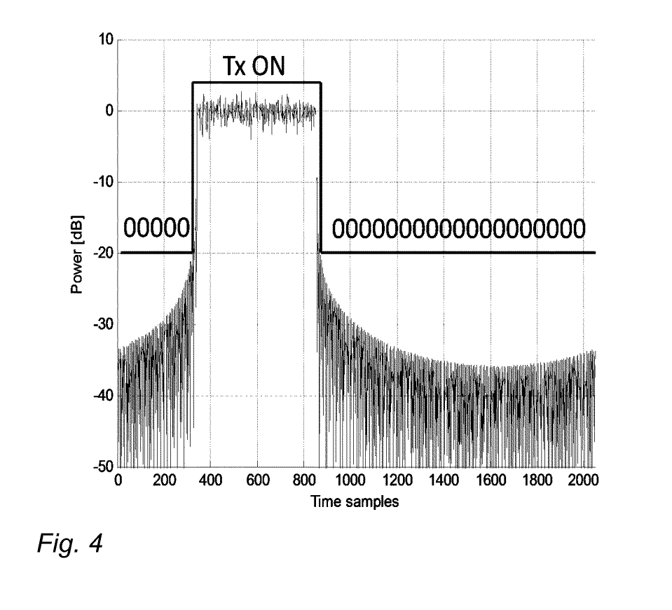

FIG. 4 illustrates a snapshot of the short SC-FDM signal. The radio frequency circuitry of the device may be turned on only for transmitting the portion of samples with a significant power amplitude. FIG. 4 shows a snapshot of the signal s, assuming that N_{IFFT}=2048, N=1200, N_{data}=300, n₀=340, and n₁=852. Such a vector presents the significant power amplitude only in the desired interval of the samples [n₀,n₁]. It may then undergo a zero-placing operation, i.e. a vector \tilde{s} is transmitted: \tilde{s}=└0ₙ_{₀} s(n₀:n₁) 0_{N}_{_{IFFT}}₋ₙ_{₁}₊₁┘d.

The radio frequency circuitry of the transmitter may then be activated only for the transmission of the non-zero samples of \tilde{s}.

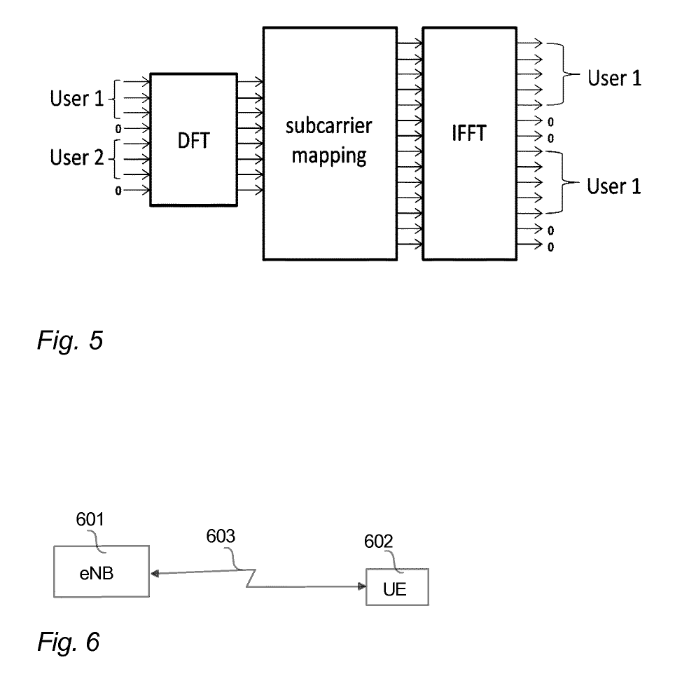

An extension to a multiuser case in the downlink is straightforward: the data of multiple UEs may be allocated over a different part of a DFT input, as shown in FIG. 5. FIG. 5 illustrates multiplexing of users in the downlink by using a short SC-FDM principle.

As mentioned above, a certain guard time GT (i.e. guard period) needs to be allocated between the signals dedicated to the different users, in order to accommodate an expected root mean square delay spread of the radio channel. By denoting with n_{δ} a guard period GP length in terms of time samples,

$$⌊ \frac{{n}_{δ} N}{{N}_{IFFT}} ⌋$$

zeros need to be inserted between the data symbols of the different UEs at the input of DFT. The presence of guard period GP allows avoiding cyclic prefix CP insertion which may be kept only for eventual backwards compatibility constraints with existing radio standards.

In the downlink case, the radio frequency circuitry at UE may be activated only for retrieving the portion of samples in an interval [n₀,n₁+n_{δ}], where the addition of the n_{δ} samples with respect to the transmit interval [n₀,n₁] is meant to collect the energy dispersion due to the frequency selective channel. This enables the usage of traditional frequency domain equalization. A (n₁+n_{δ}−n₀)-length vector r is then zero-padded such that it may have a length N_{IFFT} (i.e. \tilde{r}=└0ₙ_{₀} r 0_{N}_{_{IFFT}}₋ₙ_{₁}₋ₙ_{_{δ}}₊₁┘) and may then undergo the traditional SC-FDM receive processing.

By assuming transmission over an ideal channel with a unitary response, an estimate of a vector q may be obtained as follows: \hat{q}=F_{N}⁻¹M⁻¹F_{N}_{_{IFFT}}\tilde{r}^{T}.

An estimate of the data vector d is then simply given by

$$\hat{d} = \hat{q} ( ⌊ \frac{{n}_{0} N}{{N}_{IFFT}} ⌋ \text{:} ⌊ \frac{( {N}_{IFFT} - {n}_{1} + 1 ) N}{{N}_{IFFT}} ⌋ ) .$$

In case of transmission over a fading channel, traditional frequency domain equalization may be applied. It should be noted that, since the transmit vector \tilde{s} is obtained by removing a part of the samples of the original IFFT output, some minor degradation is expected in the retrieved data vector. However, given the low power magnitude of the removed samples, such degradation is not expected to be significant.

An exemplary embodiment differs from the methods for generating OFDM/SC-FDM signals having zeros (or very low power samples) at their tail in several aspects. There, the zeros before DFT were inserted with the aim of generating a low power tail for accommodating delay spread/propagation delay, without any multi-user aspect. Moreover, there it was not meant to reduce the active time of the radio frequency circuitry of the device since the low power samples in the tail were also transmitted with the aim of entirely preserving the subcarrier orthogonality. Here, in an exemplary embodiment, the insertion of the zero-placing block allows reducing the active time of the device at the expense of degradation in the receive signal. However, as stated above, such degradation is minimal due to the extremely low power of the removed samples.

FIG. 1 illustrates frequency domain scheduling (a) vs. time domain scheduling (b), assuming the OFDM/SC-FDM symbol duration as a minimum time granularity.

FIG. 3 illustrates the short SC-FDM signal generation according to an exemplary embodiment.

An exemplary embodiment enables having very short active/ON durations for the transmission of very small data segments.

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, server, corresponding component, and/or to any communication system or any combination of different communication systems that support an OFDM baseband processing chip. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE (or LTE-A) (long term evolution (advanced long term evolution)), without restricting the embodiment to such an architecture, however.

A general architecture of a communication system is illustrated in FIG. 6. FIG. 6 is a simplified system architecture only showing some elements and functional entities, all being logical units whose implementation may differ from what is shown. The connections shown in FIG. 6 are logical connections; the actual physical connections may be different. It is apparent to a person skilled in the art that the systems also comprise other functions and structures. It should be appreciated that the functions, structures, elements and the protocols used in or for signal processing, are irrelevant to the actual invention. Therefore, they need not to be discussed in more detail here.

The exemplary radio system of FIG. 6 comprises a network node 601 of a network operator. The network node 601 may include e.g. an LTE (or LTE-A) base station (eNB), radio network controller (RNC), or any other network element, or a combination of network elements. The network node 601 may be connected to one or more core network (CN) elements (not shown in FIG. 6) such as a mobile switching centre (MSC), MSC server (MSS), mobility management entity (MME), gateway GPRS support node (GGSN), serving GPRS support node (SGSN), home location register (HLR), home subscriber server (HSS), visitor location register (VLR). In FIG. 6, the radio network node 601 that may also be called eNB (enhanced node-B, evolved node-B) or network apparatus of the radio system, hosts the functions for radio resource management in a public land mobile network. FIG. 6 shows one or more user equipment 602 located in the service area of the radio network node 601. The user equipment or UE refers to a portable computing device, and it may also be referred to as a user terminal. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer. In the example situation of FIG. 6, the user equipment 602 is capable of connecting to the radio network node 601 via a connection 603.

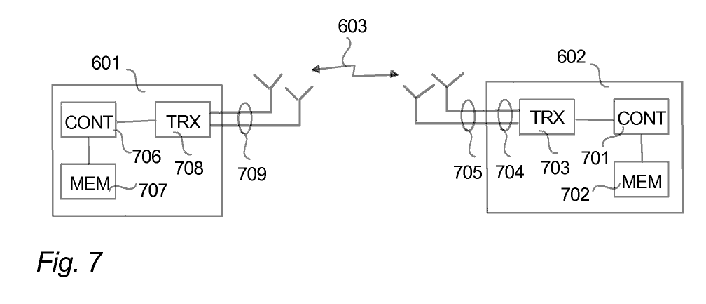

FIG. 7 is a block diagram of an apparatus according to an embodiment of the invention. FIG. 7 shows a user equipment 602 located in the area of a radio network node 601. The user equipment 602 is configured to be in connection with the radio network node 601. The user equipment or UE 602 comprises a controller 701 operationally connected to a memory 702 and a transceiver 703. The controller 701 controls the operation of the user equipment 602. The memory 702 is configured to store software and data. The transceiver 703 is configured to set up and maintain a wireless connection 603 to the radio network node 601. The transceiver 703 is operationally connected to a set of antenna ports 704 connected to an antenna arrangement 705. The antenna arrangement 705 may comprise a set of antennas. The number of antennas may be one to four, for example. The number of antennas is not limited to any particular number. The user equipment 602 may also comprise various other components, such as a user interface, camera, and media player. They are not displayed in the figure due to simplicity. The radio network node 601, such as an LTE base station (eNode-B, eNB) comprises a controller 706 operationally connected to a memory 707, and a transceiver 708. The controller 706 controls the operation of the radio network node 601. The memory 707 is configured to store software and data. The transceiver 708 is configured to set up and maintain a wireless connection 603 to the user equipment 602 within the service area of the radio network node 601. The transceiver 708 is operationally connected to an antenna arrangement 709. The antenna arrangement 709 may comprise a set of antennas. The number of antennas may be two to four, for example. The number of antennas is not limited to any particular number. The radio network node 601 may be operationally connected (directly or indirectly) to another network element (not shown in FIG. 7) of the communication system, such as a radio network controller (RNC), a mobility management entity (MME), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server, via an interface. The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 601, 602 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, and a line telephone.

The apparatus 601, 602 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The memory 702, 707 may include volatile and/or non-volatile memory and typically stores content, data, or the like. For example, the memory 702, 707 may store computer program code such as software applications (for example for the detector unit and/or for the adjuster unit) or operating systems, information, data, content, or the like for a processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

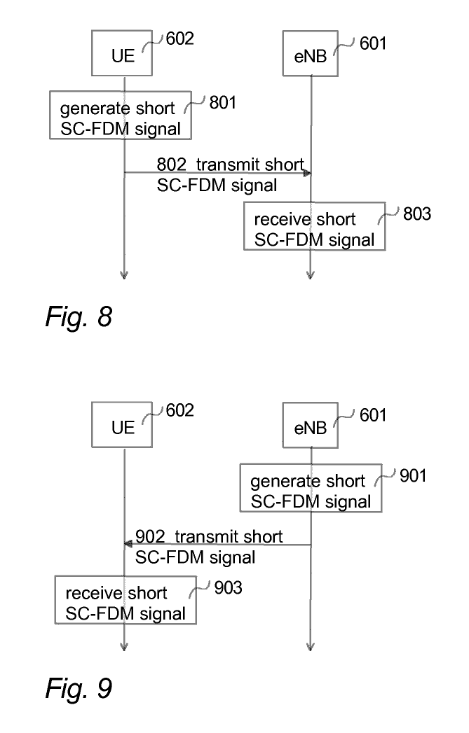

The signalling chart of FIG. 8 illustrates the required signalling when applied in the uplink. In the example of FIG. 8, a first network apparatus 602 which may comprise e.g. a network element (network node, e.g. a user terminal, UE) may generate 801 a single carrier frequency division multiplexing SC-FDM signal having a shorter duration than a time symbol duration defined by a radio standard applied in the radio system. In item 802, the first network apparatus 602 may transmit the generated short SC-FDM signal to a second network apparatus 601 (which may comprise e.g. a LTE/LTE-A-capable base station (eNode-B, eNB)). In item 803, the second network apparatus 601 may receive the short SC-FDM signal transmitted from the user terminal UE, 602, such that orthogonality of frequency subcarriers is maintained at a receiver of the signal.

The signalling chart of FIG. 9 illustrates the required signalling when applied in the downlink. In the example of FIG. 9, a second network apparatus 601 which may comprise e.g. a network element (network node, e.g. a LTE/LTE-A-capable base station (eNode-B, eNB)) may generate 901 a single carrier frequency division multiplexing SC-FDM signal having a shorter duration than a time symbol duration defined by a radio standard applied in the radio system. In item 902, the second network apparatus 601 may transmit the generated short SC-FDM signal to a first network apparatus 602 (which may comprise a network node, e.g. a user terminal, UE). In item 903, the first network apparatus 602 may receive the short SC-FDM signal transmitted from the base station eNB, 601.

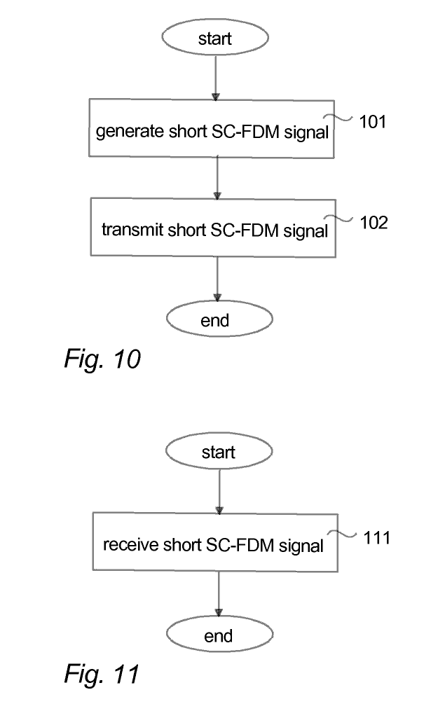

FIG. 10 is a flow chart illustrating an exemplary embodiment. In FIG. 10, in an uplink implementation, a first network apparatus 602 which may comprise e.g. a network element (network node, e.g. a user terminal, UE) may generate 101 a single carrier frequency division multiplexing SC-FDM signal having a shorter duration than a time symbol duration defined by a radio standard applied in the radio system. In item 102, the first network apparatus 602 may transmit the generated short SC-FDM signal to a second network apparatus 601 (which may comprise e.g. a LTE/LTE-A-capable base station (eNode-B, eNB)). In FIG. 10, in a downlink implementation, the second network apparatus 601 may generate 101 a single carrier frequency division multiplexing SC-FDM signal having a shorter duration than a time symbol duration defined by a radio standard applied in the radio system. In item 102, the second network apparatus 601 may transmit the generated short SC-FDM signal to the first network apparatus 602.

FIG. 11 is a flow chart illustrating an exemplary embodiment. In FIG. 11, in an uplink implementation, a second network apparatus 601 which may comprise e.g. a network element (network node, e.g. a LTE/LTE-A-capable base station (eNode-B, eNB)) may receive a short SC-FDM signal transmitted from a first network apparatus 602 which may comprise e.g. a network element (network node, e.g. a user terminal, UE). In FIG. 11, in a downlink implementation, the first network apparatus 602 may receive the short SC-FDM signal transmitted from the second network apparatus 601.

The steps/points, signalling messages and related functions described above in FIGS. 1 to 11 are in no absolute chronological order, and some of the steps/points may be performed simultaneously or in an order differing from the given one. Other functions can also be executed between the steps/points or within the steps/points and other signalling messages sent between the illustrated messages. Some of the steps/points or part of the steps/points can also be left out or replaced by a corresponding step/point or part of the step/point. The apparatus operations illustrate a procedure that may be implemented in one or more physical or logical entities. The signalling messages are only exemplary and may even comprise several separate messages for transmitting the same information. In addition, the messages may also contain other information.

It will be obvious to a person skilled in the art that, as the technology advances, the inventive concept can be implemented in various ways. The invention and its embodiments are not limited to the examples described above but may vary within the scope of the claims.

### List of Abbreviations

OFDM orthogonal frequency division multiplexing

SC-FDM single carrier frequency division multiplexing

MIMO multiple input multiple output

FFT fast Fourier transform

IFFT inverse FFT

LTE long term evolution

LTE-A LTE-advanced

AP access point

UE user equipment

SR scheduling request

HARQ hybrid automatic repeat request

HSPA high speed packet access

HS-DPCCH high speed dedicated physical control channel

DFT discrete Fourier transform

TDD time division duplex

1.-16. (canceled)

17. A method for signal processing in a radio system, the method comprising:
generating, in an apparatus, a single carrier frequency division multiplexing SC-FDM signal having a shorter duration than a time symbol duration defined by a radio standard applied in the radio system; and
transmitting the signal from the apparatus,
wherein orthogonality of frequency subcarriers is maintained at a receiver of the signal.

18. A method for signal processing in a radio system, the method comprising:
receiving, at an apparatus, a signal from a communications device, said signal being generated in the communications device and comprising a single carrier frequency division multiplexing SC-FDM signal having a shorter duration than a time symbol duration defined by a radio standard applied in the radio system;
wherein orthogonality of frequency subcarriers is maintained at the apparatus.

19. The method as claimed in claim 17, further comprising setting a user terminal to transmit or receive only over a portion of the time symbol duration defined by the radio standard applied in the radio system.

20. The method as claimed in claim 17,
wherein access point schedules control information for multiple user terminals over different portions of a same orthogonal frequency division multiplexing OFDM symbol, and wherein each user terminal is able to turn on its receive chain only for its corresponding portion of the time symbol duration.

21. The method as claimed in claim 17, wherein synchronized frame timing is applied between an access point and a user terminal, and wherein the access point and the user terminal both operate in a time division duplex mode.

22. The method as claimed in claim 17, further comprising allocating a single control symbol for each transmission direction in a time interleaved fashion.

23. The method as claimed in claim 18, further comprising:
decoding scheduling information in a user terminal, said scheduling information being transmitted in a downlink control symbol from an access point to multiple user terminals; and
transmitting a reply in an uplink control symbol from the user terminal to the access point.

24. The method as claimed in claim 17, wherein user terminals are scheduled over different portions of a same time symbol, with an appropriate guard time between transmission opportunities to mitigate inter-symbol interference.

25. The method as claimed in claim 18, wherein a user terminal receives only its dedicated portion of samples, and turns off its receive circuitry for a remaining part of the symbol, and wherein the user terminal is ready to transmit its reply with a certain timing advance.

26. The method as claimed in claim 17, wherein a user terminal transmits only over a portion of the time symbol duration, and turns off its transmit circuitry for a remaining part of the symbol.

27. The method as claimed in claim 17, further comprising defining an output vector s:
s=F_{N}_{_{IFFT}}⁻¹MF_{N}q^{T} (1),
wherein
a vector
$$q = [ {0}_{⌊ \frac{{n}_{0} N}{{N}_{IFFT}} ⌋} d {0}_{⌊ \frac{( {N}_{IFFT} - {n}_{1} + 1 ) N}{{N}_{IFFT}} ⌋} ] ,$$
N_{IFFT} is an inverse fast Fourier transform size,
N is the length of an original data vector,
F_{P} is a P×P fast Fourier transform matrix,
M is a N_{IFFT}×N subcarrier mapping matrix,
0ₓ is a vector of zeros having a length x,
└x┘ is the largest integer smaller than x,
(•)^{T} is a transpose operator, and
wherein data is to be transmitted in the interval of time samples [n₀,n₁] of an SC-FDM symbol, with n₀≧0 and n₁<N_{IFFT}, the portion of time samples accommodating a set of data symbols d having a length
$${N}_{data} = ⌊ \frac{( {n}_{1} - {n}_{0} + 1 ) N}{{N}_{IFFT}} ⌋ .$$

28. The method as claimed in claim 27, further comprising:
turning on a radio frequency circuitry of the apparatus only for transmitting the portion of samples with a significant power amplitude, wherein the vector s presents the significant power amplitude only in a desired interval of the samples [n₀,n₁];
performing a zero-placing operation on the vector s, wherein a vector \tilde{s} is transmitted such that \tilde{s}=└0ₙ_{₀} s(n₀:n₁) 0_{N}_{_{IFFT}}₋ₙ_{₁}₊₁┘; and
activating a radio frequency circuitry of the transmitter only for transmission of non-zero samples of the vector \tilde{s}.

29. The method as claimed in claim 27,
further comprising allocating a certain guard time between signals dedicated to different user terminals, in order to accommodate an expected root mean square delay spread of a radio channel; and
inserting
$$⌊ \frac{{n}_{δ} N}{{N}_{IFFT}} ⌋$$
zeros between data symbols of different user terminals in an input of a discrete Fourier transform, wherein n_{δ} is a guard time length in terms of time samples.

30. The method as claimed in claim 27, further comprising activating a radio frequency circuitry in a user terminal in downlink only for retrieving a portion of samples in an interval [n₀,n₁+n_{δ}].

31. An apparatus, comprising:
at least one processor; and
at least one memory including computer program code,
the at least one memory and the computer program code configured to, with the at least one processor, cause the apparatus at least to
generate a single carrier frequency division multiplexing SC-FDM signal having a shorter duration than a time symbol duration defined by a radio standard applied in the radio system; and
transmit the signal from the communications apparatus,
wherein orthogonality of frequency subcarriers is maintained at a receiver of the signal.

32. An apparatus, comprising:
at least one processor; and
at least one memory including computer program code,
the at least one memory and the computer program code configured to, with the at least one processor, cause the apparatus at least to
receive a signal from a communications device, said signal being generated in the communications device and comprising a single carrier frequency division multiplexing SC-FDM signal having a shorter duration than a time symbol duration defined by a radio standard applied in the radio system;
wherein orthogonality of frequency subcarriers is maintained at the apparatus.

33. The apparatus as claimed in claim 31, further comprising setting a user terminal to transmit or receive only over a portion of the time symbol duration defined by the radio standard applied in the radio system.

34. The apparatus as claimed in claim 31, wherein an access point schedules control information for multiple user terminals over different portions of a same orthogonal frequency division multiplexing OFDM symbol, wherein each user terminal is able to turn on its receive chain only for its corresponding portion of the time symbol duration.

35. The apparatus as claimed in claim 32, wherein a user terminal receives only its dedicated portion of a sample, and turns off its receive circuitry for a remaining part of a symbol.

36. The apparatus as claimed in claim 31, wherein a user terminal transmits only over a portion of the time symbol duration, and turns off its transmit circuitry for a remaining part of a symbol.

37. A non-transitory computer readable medium embodying at least one computer program code, the at least one computer program code executable by at least one processor to perform a method comprising:
generating, in an apparatus, a single carrier frequency division multiplexing SC-FDM signal having a shorter duration than a time symbol duration defined by a radio standard applied in the radio system; and
transmitting the signal from the apparatus,
wherein orthogonality of frequency subcarriers is maintained at a receiver of the signal.
